(19) United States
(12) Patent Application Publication
(10) Pub. No.: US 2015/0335149 A1
(43) Pub. Date: Nov. 26, 2015

(54) Platformed Multipurpose Desktop Organizer

(71) Applicant: Paul Thomas Vickers, Lakeview, AR (US)

(72) Inventor: Paul Thomas Vickers, Lakeview, AR (US)

(21) Appl. No.: 14/712,033

(22) Filed: May 14, 2015

(51) Int. Cl. A47B 23/04; A47B 21/06; F16B 1/00

(52) U.S. Cl. CPC A47B 23/044; F16B 1/00; A47B 21/06; F16B 2001/0028; A47B 2021/066

(57) ABSTRACT

A Multipurpose Desktop Organizer, is supported by a platform, supporting it's geographical wood components seated on its face. The Pen and Pencil containers glued into a routered groove, for durability, the cell phone port supports the cell phone in cased in the pocket and retained by Velcro. The I phone, I pad and Tablet ports, support these devices, rotating to accommodate the rotating function of the I Phone and Tablet.

The Multipurpose Desktop Organizer offers a new style of pen-pencil container and envelope divider, and for the first time ever, a Cell Phone Port in its model type(s). This also includes different material(s) (e.g. Wood & Plexiglas), for its design approach. Instead of the common metal type that uses bends in the metal to fabricate its shape, Wood and Plexiglas, are used in this design, with the use of unique construction methods: The components base (bottom) shape of the organizer are exacted on the platform and mortise-routered, to an exact fit onto the platform—this technique is without precedent. (see Drawing #1, 2 & 3 and photo's 1,2,& 3) The various components are glued into the base, for additional durability.

### Components:

Platform The platform is Wood for the Wood model and Plexiglas for that model. It is 5.5 in. in width, 22 in. in length for both full models and 0.5 or ½ in. in thickness. The smaller models are 11 in. in length, for the separate models (see photos 4,5,& 6) and drawing #6. the Plexiglas models will have a ¼ thickness for the platform and the same dimensions as the Wood models.

1: Pencil & Pen containers: The octagon or square pencil-pen container (see drawings 1,2,3,& 4 photos 1,2,& 3. All containers are 4″×4″ at the base, and 4.25″ in. ht. made of ¼″ Wood or Plexiglas material, and glued together in 4 (square) or 8 (octagon), different parts.

Cell Phone Port: This port is both integrated as a component in model #1 and separated as an individual device that is specifically for the placement of a Cell Phone. The Cell Phone Port will be set in a 11″ platform, will be 7″ in ht. and 4×4″ in width, set at a 26 degrees right angle pitch. The Pocket will be 3.5 w.″×6.25 ht.″ Other sizes pockets are to be included for Tablets and ipads. The only change in design for these two models, will be the length and height. This design is also a separate claim. (see drawing #1 & 6 and photos #2,6,10 & 11). This model also includes a Plexiglas version. (see photo #10 and 11).

Use of Velcro: The use of Velcro is integral to the stability of these designs. Velcro will be utilized at the bottom of the platform, and within the Dish-Pocket of the Cell Phone Port. The use of Velcro to stabilize the Desktop Organizer to the top of any desk, Table or nightstand and a strip that is placed in the pocket of the Cell Phone Dish-Pocket and on the back of a Cell Phone, offers a unique usage for Velcro. This is important material that gives additional uniqueness to the functionality of both designs. (see Drawing 2 detail #4 & photo #10)

### DESCRIPTION OF VIEWS (DRAWINGS)

FIG. 1: Flat/Floor view—Platform details: View illustrates overall length, width, and length, of each component and its distance between objects on Platform. see details

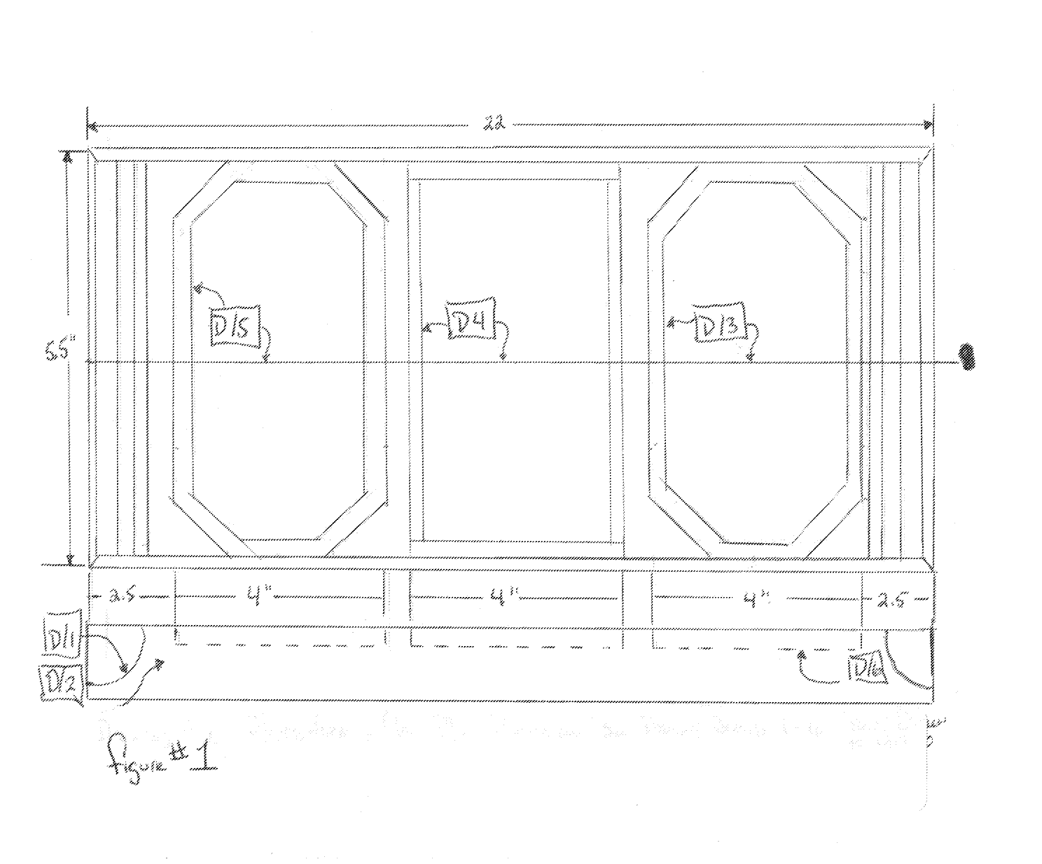

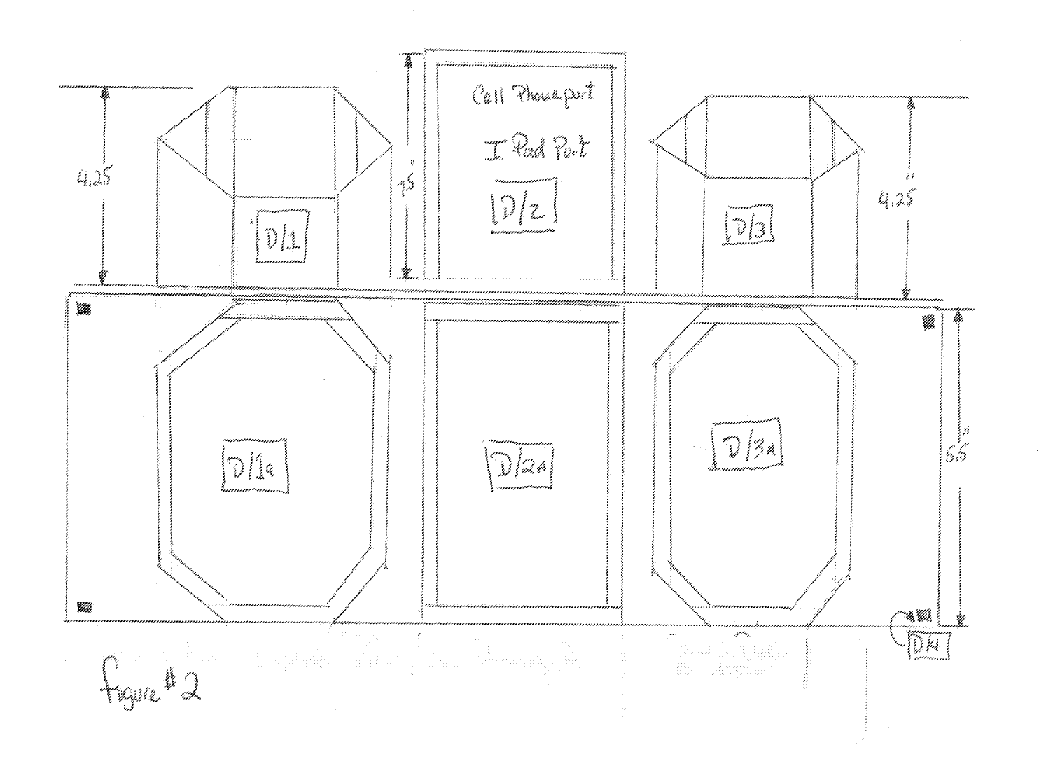

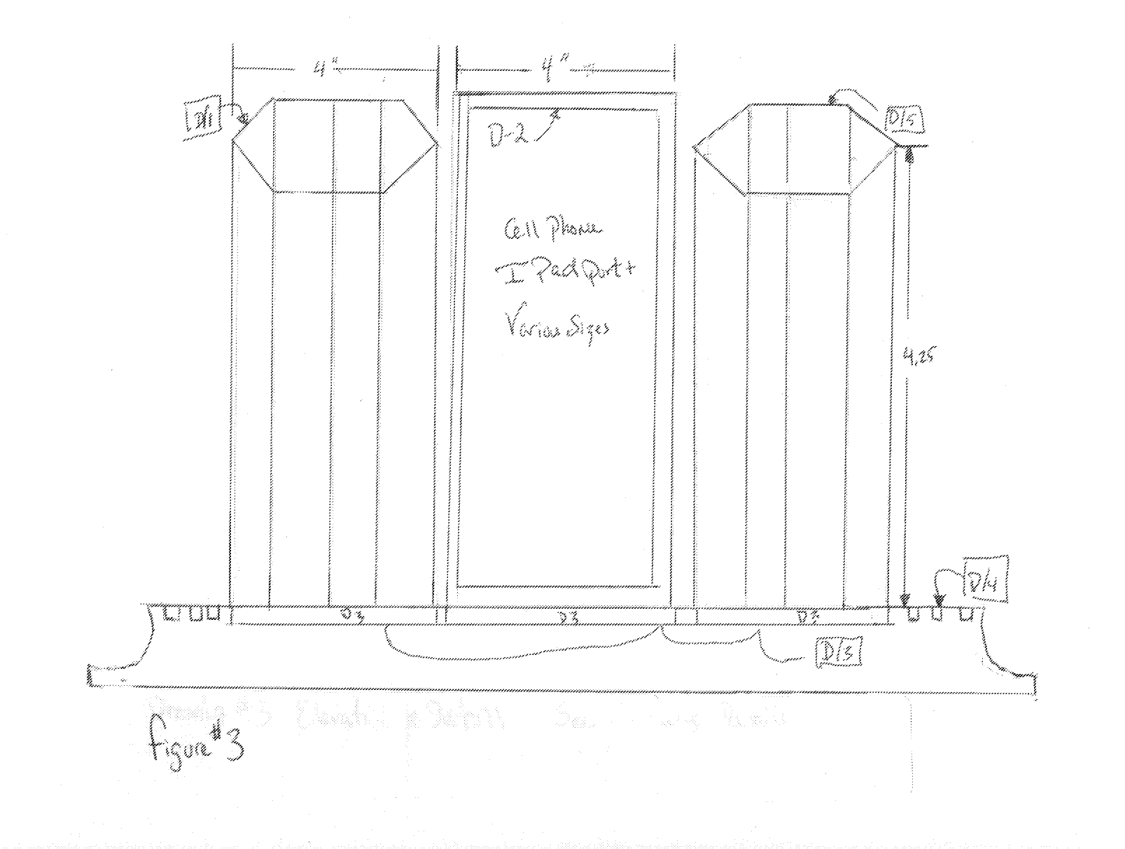

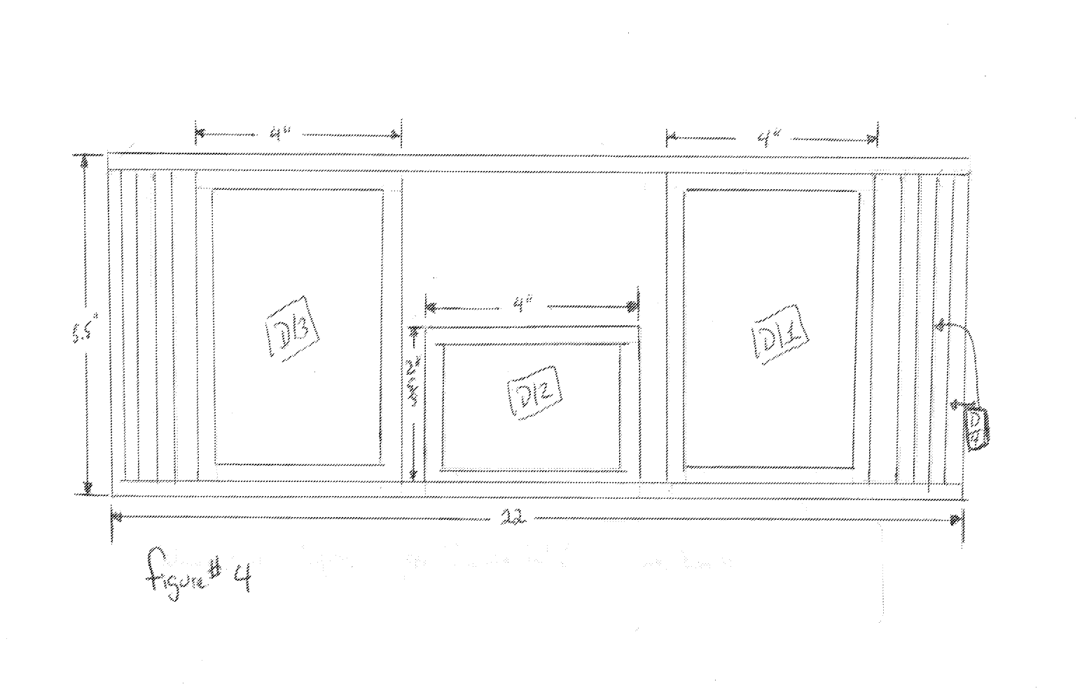

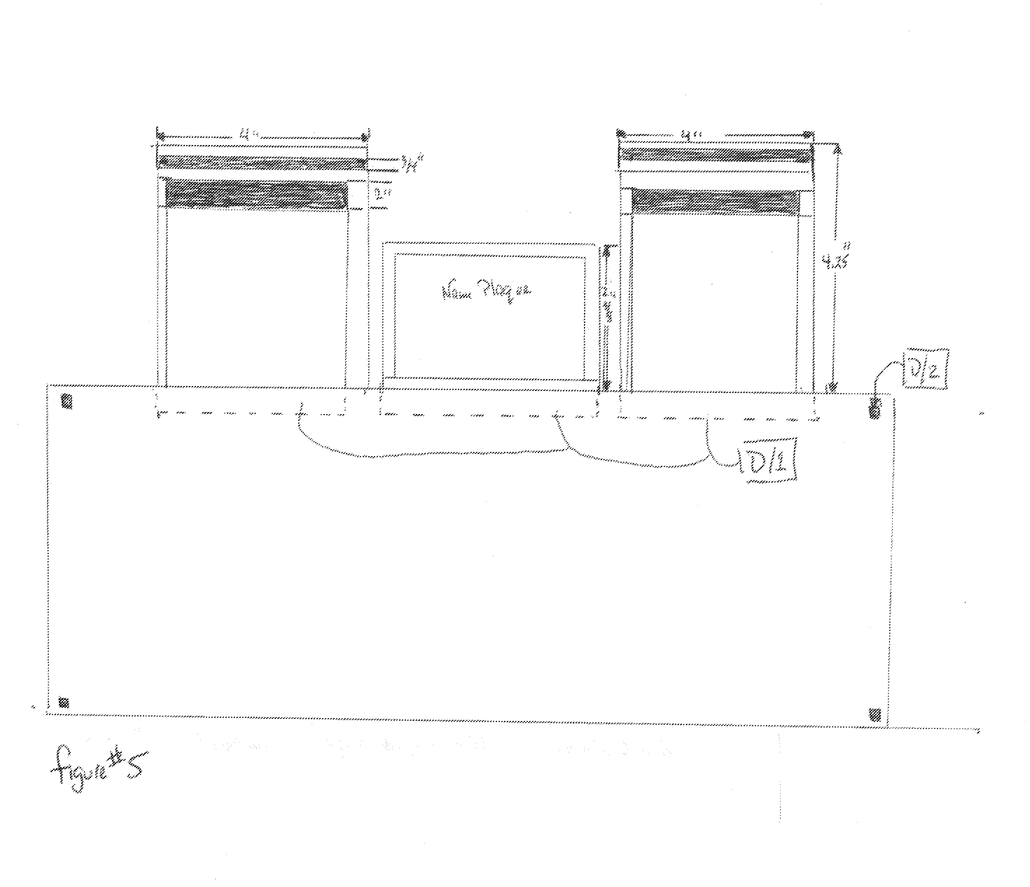

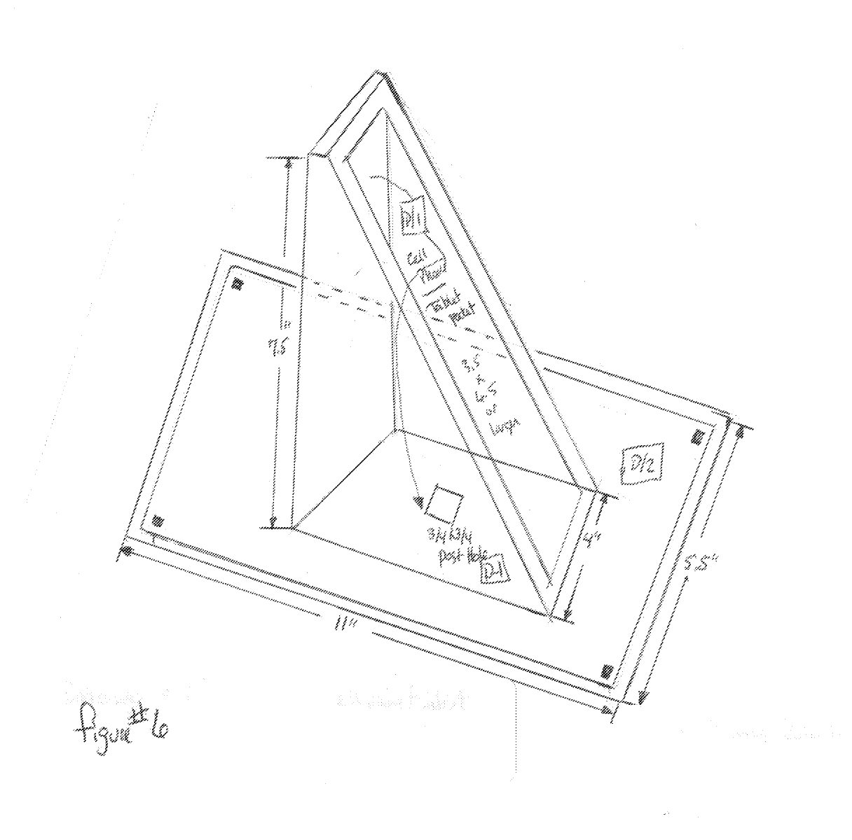

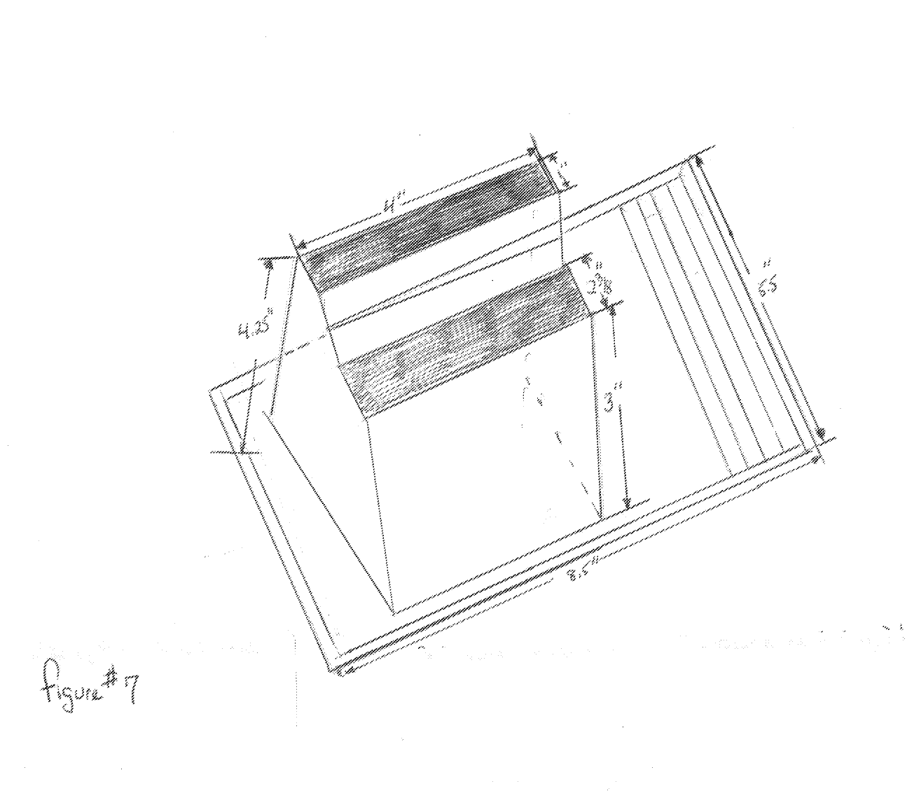

Detail 1 (D/1) illustrates Platform details: the rounded edge, height-width, length & thickness of Platform

Detail 2 (D/2) dimensions—placement area, router mortised grooves for envelope dividers length, width, thickness, depth of mortise groove(s)

Detail 3 (D/3) illustrates dimensions—placement area—shape and size of octagon container. Shape length, width of router mortise grooves for octagon pen-pencil container.

Detail 4 (D/4) illustrates dimensions—placement area, dimensions shape, width length of cell, phone port router mortised

Detail 5 (D/5) illustrates Dimensions placement area of router mortised grooves of octagon pen-pencil container, dimensions of router mortise

6 (D/6) depth of all router mortised grooves.

FIG. 2: Exploded View a illustrates the Platform and placement objects (containers & cell phone port, and the location, Heights of containers: placement of Velcro.

Detail 1 (D/1) wood parts for containers & cell phone port are of ¼″ wood or plexi-glass material cut at both 22.5 degree and square or 90 degree angles. The octagon and square pieces are 4.25 in ht.

Detail 2 (D/2) the cell phone pieces axe 7.5′ in ht. the face is 4.0″ w. with 0.25 in. reveal around the perimeter, inside to inside dimensions in the pocket are 6.25″×3.5″This is only for the cell Phone port. The I pad and Tablet ports will be of different dimensions. These dimensions are according to models of these products on the market. They will also be extended vertically on a stand (Height). Some models will rotate 360 degrees on the stand, to accommodate, the rotating function of these devices (e.g. I Pads, Tablets). They will lock in place with a bolt and wing-nut set up, on the post. The post will be approx. ¾ w ×¾ w.×6″ ht. set in the platform by a router mortis opening to fit the ¾″×¾″ in. post.

Detail 3 (D/3) illustrates placement of pen-pencil container, ht.

FIG. 3 Front elevation view

Detail 1 (D/1) ¼ in. pieces, eight sides, 4″ total across all outside walls.

Detail 2 (D/2) router mortise depth ¼″ deep, around the cell phone port, to create pocket reveal ¼″ on all sides.

Detail 3 (D/3) router mortise 0.25″ deep for all objects place in platform with the exception of the ipad and Tablet stands. raised up above the containers at 6″, on ¾″×¾″ or sq. or rounded post, mortise routered into the platform, or separate platform without the containers.

Detail 4 (D/4) envelope dividers mortise grooves 0.25″ deep

Detail 5 (D/5) Octagon eight sided containers cut at 22.5 degrees on both sides for all Pieces.

FIG. 4 Flat or Floor view/Multipurpose Desktop or model illustrates overall length.of Platform.width dimensions, distance between components

Detail 1 (D/1) 4″×4″ mortise routered perimeter for container area

Detail 2 (D/2) router perimeter for name plaque dimensions 4″×2″×6.25 in.

Detail 3 (D/3) router mortise perimeter for container.

Detail 4 (D/4) mortise router width and length for envelope dividers.

FIG. 5 Elevation view (square model) illustrates width-height(s) of component and mortise routered areas

Detail 1 (D/1) illustrates router width and depth, height and width of components size-dimensions of container openings

Detail 2 (D/2) Placement of velcro on the bottom of platform.

FIG. 6 Separate platform cell phone component, length and width of platform height of cell phone port. Placement of Velcro at bottom of platform.

Detail 1 (D/1) The routered cellphone pocket different size(s) for i Pad and Tablet. does not illustrate, 6″ vertical post for i Pad and Tablet and alternate phone set up. .(D/1) area of ¾″×¾ router mortised pocket for application of 6″ vertical stand for I Pad and Tablet models.

Detail 2 (D/2) 11″×5.5″ platform

Detail 3 (D/3) placement of Velcro a bottom of platform.

FIG. 7 Separated square platform and pen-pencil container model. Note: separate octagon model not illustrated.illustrates length and width of platform Height of container, width of container, openings.

Detail 1 (D/1) 3 envelope dividers.

1. The Multipurpose Platformed Desktop Organizers aesthetic designs combined with Wood or Plexiglas, is unique to any organizer. In addition, the construction methods used to create it are uncharted and unique. The platform provides more stability: this stability combined with the use of Velcro, provides a never before approach to solve the problem of spills and having to locate the pen l container close to other objects for protection against spills, or having to place these organizers and containers at a location that may not be desirable.
The introduction of the Cell Phone Port either integrated into a full platform or by itself a a separate item is also unique. There are plastic and elastic models for Tablet s and ipads, (but non for I-phones—or Cell Phones), that unfold to create a unstable operating table.but non known to the inventor that are totally stable with a platform and Velcro fastening characteristics as does this Cell Phone Port.
